(19) United States
(12) Patent Application Publication
(10) Pub. No.: US 2026/0208643 A1
(43) Pub. Date: Jul. 23, 2026

(54) PANEL FRAME STRUCTURE

(71) Applicants: TS TECH CO., LTD., Asaka-shi (JP); HONDA MOTOR CO., LTD., Tokyo (JP)

(72) Inventors: Takeshi SATO, Tochigi (JP); Kazuya MIYAWAKI, Tochigi (JP); Hidetaka YONEHARA, Tochigi (JP); Yusuke OGATA, Wako-shi (JP)

(21) Appl. No.: 19/455,025

(22) Filed: Jan. 21, 2026

(30) Foreign Application Priority Data
Jan. 23, 2025 (JP) 2025-009752

(51) Int. Cl. B60N 2/68

(52) U.S. Cl. CPC B60N 2/686; B60N 2/682; B60N 2/688

(57) ABSTRACT

A panel frame structure includes a first panel frame and a second panel frame. The first panel frame and the second panel frame are joined in an overlapping state, the first panel frame includes: a frame along an outer edge; and a connection that is extended from a middle portion in a left-right direction of one frame portion extending in the left-right direction of the frame, and branches halfway to reach ends in the left-right direction of the other frame portion extending in the left-right direction of the frame, and an opening is formed between the frame and the connection.

### CROSS-REFERENCE TO RELATED APPLICATIONS

The present application is based upon and claims the right of priority to Japanese Patent Application No. 2025-009752 filed on Jan. 23, 2025, the disclosure of which is hereby incorporated by reference herein in its entirety for all purposes.

### BACKGROUND OF THE INVENTION

### Technical Field

The present disclosure relates to a panel frame structure.

### Description of Related Art

JP2001519281 (A) discloses a panel frame structure used for the rear seat backrest of a vehicle seat.

In this panel frame structure, a panel-shaped front frame and a panel-shaped rear frame are joined by an overall overlap. The front frame has an embossed portion that is convex to the front, and the rear frame has an embossed portion that is convex to the rear.

### SUMMARY OF THE INVENTION

Panel frame structures are required to be both strong and lightweight, and the conventional panel frame structure described above has room for improvement in terms of both of these aspects.

To achieve at least one of the abovementioned objects, according to an aspect of the present disclosure, there is provided a panel frame structure comprising a first panel frame and a second panel frame, wherein
the first panel frame and the second panel frame are joined in an overlapping state,
the first panel frame includes:
   a frame along an outer edge; and
   a connection that is extended from a middle portion in a left-right direction of one frame portion extending in the left-right direction of the frame, and branches halfway to reach ends in the left-right direction of the other frame portion extending in the left-right direction of the frame, and
an opening is formed between the frame and the connection.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a front view of a panel frame structure that is an embodiment of the present disclosure, viewed from the front;

FIG. 2 is a rear view of the panel frame structure of FIG. 1, viewed from the rear;

FIG. 3 shows a front view of the panel frame structure;

FIG. 4 shows a rear view of the panel frame structure;

FIG. 5 is a cross-sectional view along the V-V line of the panel frame structure in FIG. 3;

FIG. 6 is a cross-sectional view along the W-W line of the panel frame structure in FIG. 3; and

FIG. 7 shows a front view of a rear panel frame.

### DETAILED DESCRIPTION

### [Schematic of Embodiment of Present Disclosure]

Hereinafter, one or more embodiments of the present disclosure will be described with reference to the drawings. However, the scope of the invention is not limited to the disclosed embodiments.

The following is a description of an embodiment in which the present disclosure is to be implemented, using the drawings. However, although various technically preferred limitations are attached to the following embodiments to implement the present disclosure, the scope of the present disclosure is not limited to the following embodiments and illustrated examples.

The present embodiment is a panel frame structure applied to the backrest of a bench seat for transportation means.

The transportation means equipped with bench seats to which the panel frame structure shown below is applied include ships, flying vehicles, vehicles, and any other transportation means in which humans board and move about, but the present embodiment illustrates the application of the panel frame structure to bench seats in vehicles, in particular, automobiles.

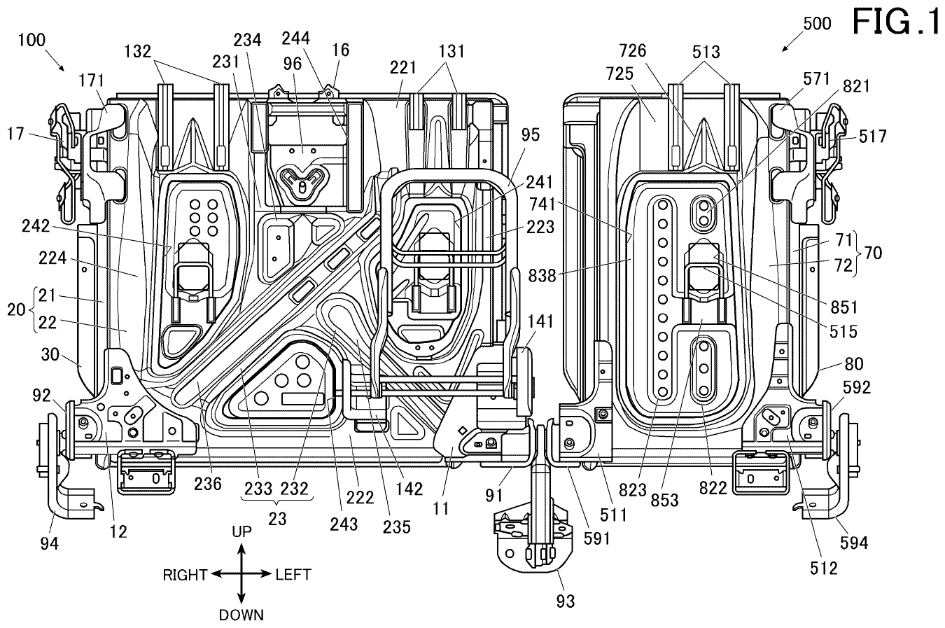

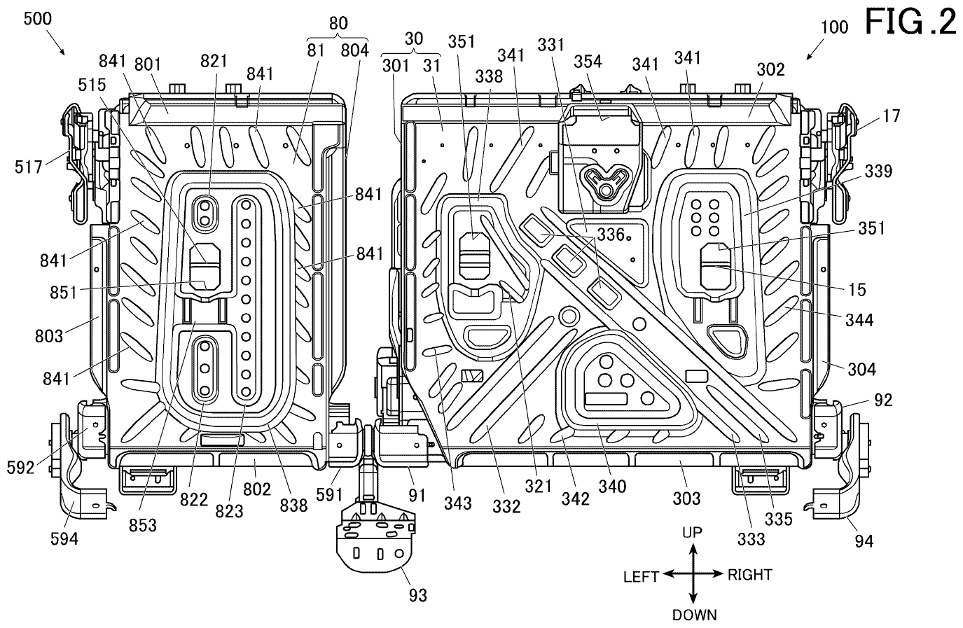

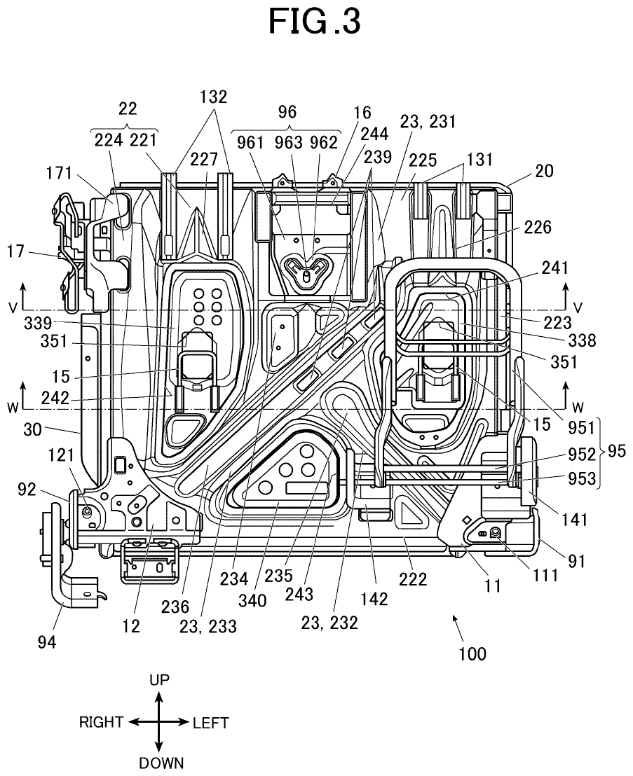

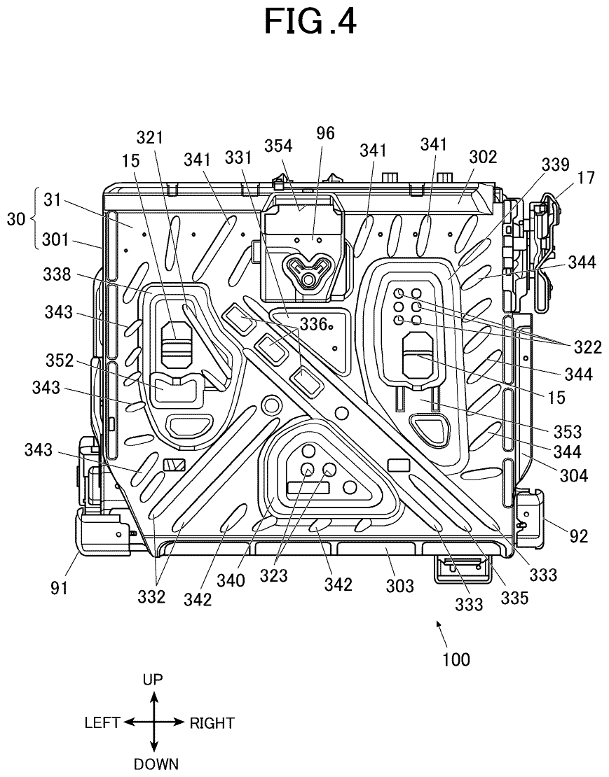

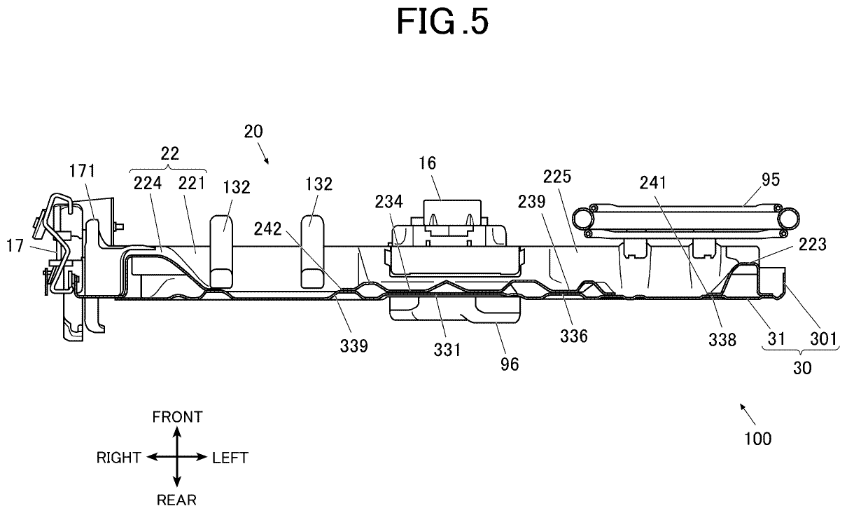

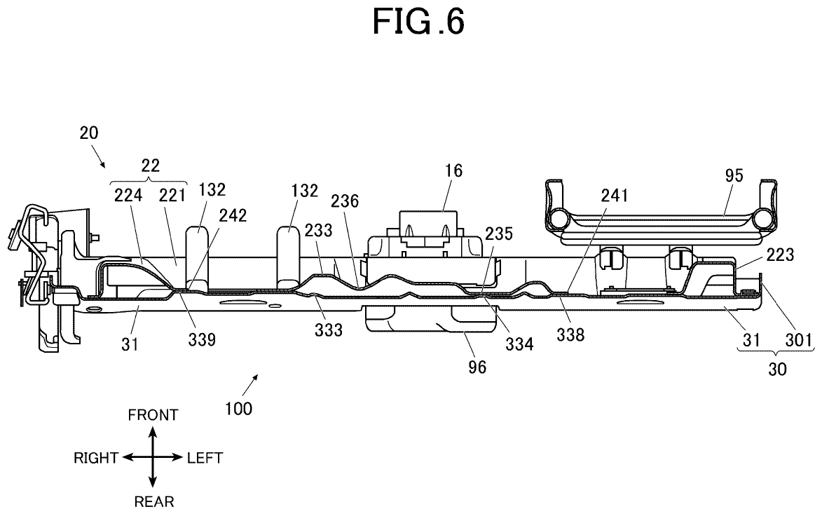

FIG. 1 shows a front view of panel frame structures 100, 500 viewed from the front and FIG. 2 shows a rear view. FIG. 3 is a front view of the panel frame structure 100, FIG. 4 is a rear view, FIG. 5 is a cross-sectional view along the V-V line in FIG. 3, and FIG. 6 is a cross-sectional view along the W-W line in FIG. 3.

In each figure, the directions of up, down, left, right, front, and rear are shown as they would be when attached to a vehicle. The following description of each part of each panel frame structure 100, 500 will be based on the directions in the above-mentioned attached state.

Although each panel frame structure 100, 500 is strictly attached to the vehicle with its upper end somewhat inclined to the rear, unless otherwise specified, the plate surface of each panel frame structure 100, 500 is assumed to be placed along the up-down direction and left-right direction for the sake of explanation.

The panel frame structures 100, 500 are for vehicles and are used as backrest frames for bench seats. The panel frame structure 100 is utilized for the backrest of a two-seat bench seat, while the panel frame structure 500 is utilized for the backrest of a single-seat bench seat.

Foam molded pads are attached to the respective panel frame structures 100, 500 so as to wrap the panel frame structures 100, 500 from the front side, and surface skins are suspended over the surfaces of these pads. The suspension means that the surface skin covering the surface of the pad is taut and placed along the surface of the pad.

### [Panel Frame Structure (1)]

As shown in FIGS. 1 to 6, the panel frame structure 100 includes a front panel frame 20 as a first panel frame, a rear panel frame 30 as a second panel frame, set brackets 11, 12 for attaching the panel frame structure 100 externally, a plurality of headrest supports 131, 132, armrest brackets 141, 142, tethers 15, a belt guide 16, a retractor bracket 96 as a retractor attachment and a lock 17.

Both the front panel frame 20 and the rear panel frame 30 are metal plates such as steel or aluminum alloy with an approximately rectangular plate shape in front view.

Both the front panel frame 20 and the rear panel frame 30 have their long sides along the left-right direction and their short sides along the up-down direction in front view. The front panel frame 20 and the rear panel frame 30 are “front” on the front side of the drawing sheet in FIGS. 1 and 3, and “rear” on the front side of the drawing sheet in FIGS. 2 and 4.

The front panel frame 20 is joined to the front side of the rear panel frame 30.

If not specifically mentioned, each component of the panel frame structure 100 is joined by welding, more preferably by laser welding (the same applies to the panel frame structure 500 described below). However, welding methods other than laser welding may be used, or joining methods other than welding may be used.

### [Schematic of Front Panel Frame]

The front panel frame 20 is joined to the front surface of the rear panel frame 30 with the entire front panel frame 20 overlapping with the rear panel frame 30, viewed from the front-rear direction. The front panel frame 20 has a somewhat smaller outer edge than the rear panel frame 30.

### [Front Panel Frame: Outer Edge]

The front panel frame 20 has an outer edge 21 that is in surface contact with the front surface of the rear panel frame 30 over its entire outer edge. The rear surface of this outer edge 21 may be entirely or partially (spot) laser welded to the front surface of the rear panel frame 30.

### [Front Panel Frame: Frame]

The front panel frame 20 has a frame 22 just inside the outer edge 21 that bulges out forward across the entire circumference along the outer edge 21. The frame 22 is separated from the front of the rear panel frame 30 to form a gap space.

The frame 22 bulges out forward along the four sides of the approximate rectangle and has an upper frame reinforcement 221 (frame portion) corresponding to the upper side, a lower frame reinforcement 222 (frame portion) corresponding to the lower side, a left frame reinforcement 223 (frame portion) corresponding to the left side, and a right frame reinforcement 224 (frame portion) corresponding to the right side.

Of these, the upper frame reinforcement 221 and lower frame reinforcement 222 extend in the left-right direction, while the left frame reinforcement 223 and right frame reinforcement 224 extend in the up-down direction.

In the following description, the term “*** reinforcement” indicates a portion or member that has higher rigidity than a flat plate due to its three-dimensional structure, such as protrusions, framed, convex, or folded portions.

The upper frame reinforcement 221 has inclined surfaces 225 that are inclined rearward toward the bottom on both the left and right sides of the connection position with a central extension 231 (described below), and reinforcements 226, 227 consisting of convex portions protruding rearward in a triangular pyramidal shape are formed on the rear sides of the left and right inclined surfaces 225. Both reinforcements 226 and 227 are concave when viewed from the front side of the front panel frame 20 and convex when viewed from the rear side.

### [Front Panel Frame: Connection]

The front panel frame 20 has a connection 23 that extends downward from the middle portion in the left-right direction of the upper frame reinforcement 221 and branches off halfway to reach both ends in the left-right direction in the lower frame reinforcement 222. As shown in FIG. 3, this connection 23 is formed in a bifurcated shape (upside-down Y-shape) in front view. The connection 23 protrudes forward overall relative to its surroundings, and its rear surface is separated forward from the front surface of the rear panel frame 30.

The above connection 23 is formed by a central extension 231 from the middle of the upper frame reinforcement 221 in the left-right direction to the branch (center of the front panel frame 20), a left extension 232 from the left end of the lower frame reinforcement 222 to the branch (center of the front panel frame 20), and a right extension 233 from the right end of the lower frame reinforcement 222 to the branch (center of the front panel frame 20), the central extension 231, left extension 232, and right extension 233 being integrated at the branch to form a bifurcated shape.

From the inclined surface 225 of the upper frame reinforcement 221 to the central extension 231, a rectangular attachment hole 244 is formed to widely penetrate through the front-rear direction through which a seat belt retractor is attached via the retractor bracket 96.

### [Front Panel Frame: Opening]

Within the inner area surrounded by the frame 22, except for the above-mentioned connection 23, are three openings 241, 242, 243, which widely penetrate the plate surface of the front panel frame 20 from front to back sides.

That is, the opening 241 is enclosed by the upper frame reinforcement 221 and left frame reinforcement 223 of the frame 22 and the central extension 231 and left extension 232 of the connection 23, and the opening 241 consists of an opening with an approximately trapezoidal shape in the top half and an approximately elliptical shape in the bottom half.

The opening 242 consists of an approximately trapezoidal-shaped opening enclosed by the upper frame reinforcement 221 and right frame reinforcement 224 of the frame 22 and the central extension 231 and right extension 233 of the connection 23.

The opening 243 consists of an approximately triangular-shaped opening enclosed by the lower frame reinforcement 222 of the frame 22 and the left extension 232 and right extension 233 of the connection 23.

As mentioned above, the frame 22 of the front panel frame 20 is overall separated from the front surface of the rear panel frame 30 by the rear side.

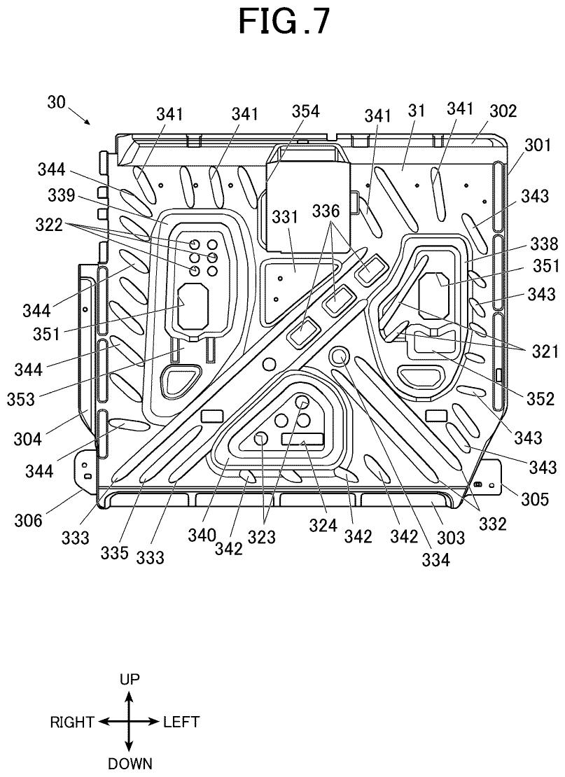

As shown in FIG. 5, the inner edges of the above respective openings 241-243 are all depressed to the rear. In contrast, at positions corresponding to the inner edges of the respective openings 241-243 of the rear panel frame 30, opening inner edge reinforcements 338-340 are formed, which consist of annular protrusions convex to the front along the shape of the inner edges of the respective openings 241-243 (see FIG. 7). The inner edge of each opening 241-243 is in contact with the front surface of the opening inner edge reinforcement 338-340 on the rear panel frame 30 side. The inner edges of these openings 241-243 may be entirely or partially (spot) laser-welded to the front surface of the opening inner edge reinforcements 338-340 of the rear panel frame 30.

### [Front Panel Frame: Front Side Connection Reinforcement]

The central extension 231, left extension 232, and right extension 233 of the connection 23 are individually formed with front side connection reinforcements 234, 235, 236, which consist of convex portions or protrusions protruding rearward (toward the rear panel frame 30).

These front side connection reinforcements 234-236 are separated at the branch of the connection 23 so that they are not integral, as shown in FIG. 3.

All of these front side connection reinforcements 234-236 are concave on the front side of the front panel frame 20 and convex on the rear side, and are in contact with the front surface of the rear panel frame 30. The rear surface of each of these front side connection reinforcements 234-236 may be entirely or partially (spot) laser-welded to the front surface of the rear panel frame 30.

The front side connection reinforcement 236 is formed along the entire length of the right extension 233 along the left diagonally upward side and extends diagonally upward to the left beyond the intersection of the central extension 231, left extension 232, and right extension 233, from the right end of the lower frame reinforcement 222 to the left end of the upper frame reinforcement 221.

The front side connection reinforcement 236 has three approximately rectangular joint reinforcements 239 which are vertically arranged and protruding rearward from the front side connection reinforcement 236 in its upper portion. The rear surface of the three spot-shaped joint reinforcements 239 is flat. At positions corresponding to the three joint reinforcements 239 in the rear panel frame 30, three approximately rectangular joint reinforcements 336 are formed, which are convex to the front and have a flat front surface. Each joint reinforcement 239 and each joint reinforcement 336 are then individually faced and joined to each other.

The front side connection reinforcement 235 is formed along the right oblique upper side and along the entire length of the left extension 232. The front side connection reinforcement 235 is formed to a position in front of the front side connection reinforcement 236 so that it does not cross the front side connection reinforcement 236.

The central extension 231 has a rectangular attachment hole 244 at its upper portion for attaching the retractor bracket 96 that supports a seat belt retractor. The front side connection reinforcement 234 is formed below the attachment hole 244 in the central extension 231. The front side connection reinforcement 234 consists of a rearward protruding convex portion that has an approximately triangular shape between the attachment hole 244 and the front side connection reinforcement 236. The front side connection reinforcement 234 has beads vertically arranged in the center of it and consisting of protrusions that are convex to the front. This allows the rearward and forward convex portions to be arranged and maintain the rigidity of the central extension 231 at a high level.

The front side connection reinforcement 234 is flat on the rear side, except for the center beads.

### [Schematic of Rear Panel Frame]

FIG. 7 is a front view of the rear panel frame 30.

As shown in FIGS. 2, 4 and 7, the rear panel frame 30 has a plate-like body plate 31 that is approximately rectangular in front view, and flange 301 and beads 302-304 integrally provided on the outer edge of the body plate 31.

### [Rear Panel Frame: Flange and Bead]

The body plate 31 is a flat plate that is overall flat along the up-down and left-right directions.

The flange 301 consists of a low-height wall portion that is erected forward from the left edge of the approximately rectangular body plate 31. The flange 301 is a reinforcement that increases the rigidity of the left edge of the body plate 31.

The beads 302-304 consist of protrusions along the respective upper, lower, and right edges of the approximately rectangular body plate 31, which bulge out more toward the front than it surroundings. The beads 302-304 are all convex forward from the front surface of the body plate 31 and concave forward when viewed from the rear. The top and bottom beads 302, 303 both have flat front surfaces and are in contact with the outer edge 21 of the front panel frame 20. The mutual contacting surfaces of the beads 302, 303 and the outer edge 21 may be joined.

### [Rear Panel Frame: Opening Reinforcement]

With the front panel frame 20 overlapping with the rear panel frame 30, opening reinforcements 321 are formed in the area of the body plate 31 that is inside the opening 241 of the front panel frame 20. The opening reinforcement 321 is convex forward from the front surface of the body plate 31 and concave forward when viewed from the rear.

In the upper right of the area that is inside the opening 241 in the body plate 31, two opening reinforcements 321 are formed, consisting of line beads along the upper left diagonal.

The area inside the opening 242 in the body plate 31 is a flat surface, and a plurality of through holes 322, circular or approximately circular, are arranged in two rows along the up-down direction at the upper portion of the surface.

The entire approximately triangular-shaped area in the area that is inside the approximately triangular-shaped opening 243 in the body plate 31 has a flat surface. A plurality of circular or approximately circular through holes 323 are formed on its flat surface in a dispersed arrangement so that they are deployed at an approximately uniform interval. A rectangular through hole 324 along the left-right direction is also formed at the bottom of the area that is inside the opening 243.

### [Rear Panel Frame: Rear Side Connection Reinforcement]

With the front panel frame 20 overlapping with the rear panel frame 30, a plurality of rear side connection reinforcements 331-335 are formed in the area in the body plate 31 that does not overlap with the respective openings 241-243 of the front panel frame 20, but overlaps with the connections 23. All of these rear side connection reinforcements 331-335 are convex forward from the front surface of the body plate 31 and concave forward when viewed from the rear surface.

In the area overlapping with the front side connection reinforcement 234 of the central extension 231 of the connection 23 in the body plate 31, a rear side connection reinforcement 331 is formed, which, as in the front side connection reinforcement 234, has an approximately triangular shape. Overall, the rear side connection reinforcement 331 is convex forward from the front surface and concave forward when viewed from the rear surface. As shown in FIG. 5, the front surface of the rear side connection reinforcement 331 is in contact with the rear surface of the front side connection reinforcement 234. These contacting surfaces may be joined to each other.

On the body plate 31, at a position on the upper side of the rear side connection reinforcement 331 and corresponding to the aforementioned seat belt retractor attachment hole 244 in the front panel frame 20, a rectangular opening 354 is formed to penetrate widely through the front-rear direction for placing the seat belt retractor.

In the area overlapping with the left extension 232 of the connection 23 in the body plate 31, two rear side connection reinforcements 332 consisting of protrusions along the left extension 232 and a rear side connection reinforcement 334 consisting of a circular convex portion are formed. The two rear side connection reinforcements 332 are located at respective ends in a direction perpendicular to the direction of extension of the left extension 232 in the area overlapping with the left extension 232. Each rear side connection reinforcement 332 is along the direction of extension of the left extension 232.

The rear side connection reinforcement 334 is arranged to overlap with the upper end of the front side connection reinforcement 235 of the left extension 232, viewed from the front-rear direction, and the front surface of the rear side connection reinforcement 334 is in contact with the rear surface of the front side connection reinforcement 235, as shown in FIG. 6. These contacting surfaces may be joined to each other.

In the area overlapping with the right extension 233 of the connection 23 in the body plate 31, rear side connection reinforcements 333, 335 are formed, which consist of protrusions or convex portions along the right extension 233. These rear side connection reinforcements 333 and 335 are located in the area overlapping with the right extension 233, respectively at both ends and in the center in a direction perpendicular to the direction of extension of the right extension 233. The rear side connection reinforcements 333 at both ends are formed in the longitudinal direction of the right extension 233 over approximately the same length as the right extension 233. In contrast, the central rear side connection reinforcement 335 is formed only within a partial range on the lower end side of the rear side connection reinforcements 333.

On the upper end side of the two rear side connection reinforcements 333, and between them, three approximately rectangular joint reinforcements 336 are vertically arranged. The joint reinforcements 336 are convex to the front, as described above, and the front surfaces thereof are joined to the rear surfaces of the three joint reinforcements 239 formed on the front side connection reinforcement 236 of the front panel frame 20, as described above.

The front side connection reinforcements 234, 235, and 236 formed in the aforementioned connection 23 are each separated from the other.

### [Rear Panel Frame: Outer Edge Reinforcement]

Outer edge reinforcements 341-344 are formed in the area around the outer edge of the body plate 31 of the rear panel frame 30, that is, the area in the body plate 31 which, in the state of the front panel frame 20 overlapping with the rear panel frame 30, does not overlap with each of the openings 241-243 and the connection 23 of the front panel frame 20 (the area outside of each of the openings 241-243 and the connection 23, that is, the area overlapping with the frame 22). These outer edge reinforcements 341-344 all consist of line-shaped beads that are convex forward from the front surface of the body plate 31, and concave forward when viewed from the rear surface.

The body plate 31 is approximately rectangular in front view, and a plurality of outer edge reinforcements 341 are arranged in the left-right direction in the area corresponding to the upper side of the body plate 31 (the area overlapping with the upper frame reinforcement 221), and a plurality of outer edge reinforcements 342 are arranged in the left-right direction in the area corresponding to the lower side of the body plate 31 (the area overlapping with the lower frame reinforcement 222).

A plurality of outer edge reinforcements 343 are arranged in the up-down direction in the area corresponding to the left side of the body plate 31 (the area overlapping with the left frame reinforcement 223), and a plurality of outer edge reinforcements 344 are arranged in the up-down direction in the area corresponding to the right side of the body plate 31 (the area overlapping with the right frame reinforcement 224).

The plurality of outer edge reinforcements 341 in the area corresponding to the upper side of the body plate 31 are all formed along a direction inclined to the upper side of the body plate 31 (non-parallel direction, for example, left diagonally downward). Some of the outer edge reinforcements 341 have a different direction(s) of extension (inclination angle) from that of the other outer edge reinforcements 341. The inclination angle of one or more of the outer edge reinforcements 341 may be different from the others, or the inclination angles of all the outer edge reinforcements 341 may all be different.

Some of the outer edge reinforcements 341 are different in length from the other outer edge reinforcements 341.

The outer edge reinforcement 341 is not connected to any of the other reinforcements, but some or all of the outer edge reinforcements 341 may be configured to connect to any of the other nearby reinforcements 331-336, 338-340.

The term “reinforcements are connected” or “reinforcements are continuous” indicates, for example, that when two reinforcements are both convex in the same direction, the convex state is maintained at their boundaries and is not interrupted. There may be a step due to the difference in the protruding amount of the two reinforcements.

The plurality of outer edge reinforcements 342 provided in the area corresponding to the lower side of the body plate 31 are also all inclined to the lower side of the body plate 31, and the direction of extension for some of the plurality of outer edge reinforcements 342 is different from others.

Some of the outer edge reinforcements 342 are different in length from the other outer edge reinforcements 342.

The case in which some of the outer edge reinforcements 342 are connected to the opening inner edge reinforcement 340 is also illustrated, but they may not be connected to any of the other reinforcements, and some or all of the outer edge reinforcements 342 may cross and be connected to any of the other nearby reinforcements 331-336, 338-340.

The plurality of outer edge reinforcements 343 provided in the area corresponding to the left side of the body plate 31 are also all inclined to the left side of the body plate 31, and the direction of extension for some of the plurality of outer edge reinforcements 343 is different from that of the other outer edge reinforcements 343.

Some of the outer edge reinforcements 343 are different in length from the other outer edge reinforcements 343.

Some of the outer edge reinforcements 343 are connected to the opening inner edge reinforcement 338, but not all of the outer edge reinforcements 343 may be connected to other reinforcements. It may also be configured so that some or all of the outer edge reinforcements 343 cross and connect to any of the other nearby reinforcements 331-336, 338-340.

The plurality of outer edge reinforcements 344 provided in the area corresponding to the right side of the body plate 31 are all inclined to the right side of the body plate 31, and the direction of extension for some of the plurality of outer edge reinforcements 344 is different from that of the other outer edge reinforcements 344.

Some of the outer edge reinforcements 344 are different in length from the other outer edge reinforcements 344.

The outer edge reinforcement 344 is not connected to any of the other reinforcements, but may be configured so that some or all of the outer edge reinforcement 344 cross and connect to any of the other nearby reinforcements 331-336, 338-340.

### [Rear Panel Frame: Tether]

The tether 15 is a member for attaching the child seat to the panel frame structure 100, and has a structure capable of fastening the hook provided by the child seat.

As shown in FIGS. 1 and 3, the tether 15 has a horizontal bar on which the hook can be fastened, and a pair of joint ends that are bent at right angles at both ends of the horizontal bar to extend in the same direction and form a rectangular flat plate, and the horizontal bar and the pair of joint ends are integrally formed.

The tethers 15 are each provided with the horizontal bar directed parallel to the left-right direction and a pair of joint ends pointing downward, having the pairs of joint ends joined to the respective left and right sides in the middle in the up-down direction of the front surface of the body plate 31 in the rear panel frame 30.

At the position where the body plate 31 overlaps with the horizontal bar of each tether 15, an octagonal-shaped clearance hole 351 is formed through the body plate 31 from front to rear so that a hook of a child seat can be fastened to each of the horizontal bars.

Each tether 15 has the pair of joint ends joined to the front surface of the body plate 31 below the clearance hole 351 in an arrangement where the horizontal bar horizontally crosses to the clearance hole 351. The pairs of joint ends of the tethers 15 are respectively joined to the joint reinforcements 352, 353 that bulge forward on the front surface of the body plate 31.

The left and right clearance holes 351 are respectively formed in the areas that are inside the openings 241, 242 of the front panel frame 20 and inside the opening inner edge reinforcements 338, 339. The joint reinforcements 352, 353, which are joined to the respective pairs of joint ends of tethers 15, are also formed within the areas that are inside the openings 241, 242 of the front panel frame 20 and inside the opening inner edge reinforcements 338, 339, respectively. The joint reinforcements 352, 353 are formed integrally by contacting the opening inner edge reinforcements 338, 339, respectively.

In other words, the joint reinforcements 352, 353 formed within the areas inside the openings 241, 242 also function as opening reinforcements that contribute to improving the rigidity and strength within the areas that are inside the openings 241, 242, similar to the aforementioned opening reinforcements 321.

[Relationship between Tether and Each Reinforcement]

As shown in FIGS. 1, 2 and 7, the joint reinforcement 352 of the tether 15 on the left side is arranged with the opening reinforcement 321, the rear side connection reinforcements 332, 333, 334, the opening inner edge reinforcement 338, and the outer edge reinforcement 343 formed around it and located adjacent to it in either direction along the plane of the body plate 31 in the rear panel frame 30. The joint reinforcement 352 is then arranged between any two of the above reinforcements for the up-down direction, left-right direction, or composite direction of up-down and left-right directions.

The joint reinforcement 353 of the tether 15 on the right side is arranged with the opening inner edge reinforcement 339, the rear side connection reinforcement 333, and the outer edge reinforcement 344 formed around it in and located adjacent to it in either direction along the plane of the body plate 31 in the rear panel frame 30. The joint reinforcement 353 is then arranged between any two of the above reinforcements for the up-down direction, left-right direction, or composite direction of up-down and left-right directions.

Furthermore, as shown in FIGS. 1 and 3, the tether 15 on the left side is arranged with the upper frame reinforcement 221, the left frame reinforcement 223, the reinforcement 226, and the front side connection reinforcements 235, 236 formed in the front panel frame 20 and located adjacent to the left tether 15 in either direction along the overall plane of the front panel frame 20 in front view. The left tether 15 is then arranged between any two of the above reinforcements for the up-down direction, left-right direction, or composite direction of up-down and left-right directions.

Similarly, as shown in FIGS. 1 and 3, the tether 15 on the right side is arranged with the upper frame reinforcement 221, the right frame reinforcement 224, the reinforcement 227, and the front side connection reinforcements 234, 236 formed in the front panel frame 20 and located adjacent to the right tether 15 in either direction along the overall plane of the front panel frame 20 in front view. The right tether 15 is then arranged between any two of the above reinforcements for the up-down direction, left-right direction, or composite direction of up-down and left-right directions.

Thus, each tether 15 is arranged adjacent to each of the reinforcements formed on the front panel frame 20 or the rear panel frame 30 or between the two reinforcements in front view, which improves the rigidity and strength around the tether 15 and enables the connected child seat to be held firmly.

### [Set Bracket]

As shown in FIGS. 1 and 3, the set bracket 11 on the left side has its base laser-welded to a support arm 305 (see FIG. 7) extending to the left from the lower left end of the rear panel frame 30 and the front side at the lower left end of the front panel frame 20, that is, the lower end of the left frame reinforcement 223.

The set bracket 12 on the right side has its base laser-welded to a support arm 306 (see FIG. 7) extending to the right from the lower right end of the rear panel frame 30 and the lower right end of the front surface of the front panel frame 20, that is, the front side at the corner where the right end of the lower frame reinforcement 222 and the lower end of the right frame reinforcement 224 cross.

The set brackets 11, 12 are connected to legs 93 and 94, respectively, which are erected on the installation surface of the seat via connecting brackets 91 and 92, respectively.

Each of the set brackets 11, 12 is a member of a metal plate thicker than the front panel frame 20 and rear panel frame 30, which is pressed into a three-dimensional structure. The set brackets 11, 12 are flanged at the outer edge to increase the rigidity of the extension against bending. The set brackets 11, 12 have flat extensions that are set back one step from the joint surface and extend to the left or right, and projection nuts 111, 121 are fixed to the front surface of the respective extensions by projection welding.

These projection nuts 111, 121 are used to connect the base of the connecting brackets 91, 92 to the rear side of the extension of the set brackets 11, 12, where the connecting bolts are screwed in. The set brackets 11, 12 and connecting brackets 91, 92 may be joined by welding, not by bolts, or by both bolts and welding.

The connecting brackets 91, 92 have arms that are raised forward from the base. The connecting brackets 91, 92 each have a flange formed on the outer edge from the base to the arm. The arms of the connecting brackets 91, 92 have the outer left and right surfaces facing those of the legs 93, 94, which are fixed to the installation surface where the seat framed by the panel frame structure 100 is installed, and are mutually rotatably connected around an axis along the left-right direction.

### [Headrest Support]

The headrest supports 131, 132 are laser-welded in pairs to the upper end of the front panel frame 20, that is, to the left and right sides of the inclined surfaces 225 of the upper frame reinforcement 221, as shown in FIGS. 1 and 3, respectively. The support 131 on the left side is shorter in length than the support 132 on the right side.

Each of the supports 131, 132 is an approximately square cylindrical member made of bent metal plate and attached to the front panel frame 20 in an orientation along the up-down direction. The headrest is then supported with the headrest pillars inserted inside each of the supports 131, 132 from above.

The aforementioned reinforcements 226, 227 formed on the inclined surfaces 225 of the front panel frame 20 are located between the attachment positions of the paired supports 131, 132, respectively, to increase the rigidity of the inclined surface 225 and the support strength of the headrest.

### [Armrest Bracket]

The armrest brackets 141, 142 are members that rotatably support the base of an armrest frame 95 equipped in the vehicle seat. The armrest frame 95 has an approximately U-shaped main frame 951, a rotation shaft 952 at the base of the main frame 951, and a regulation shaft 953 that regulates the rotation range of the main frame 951. The armrest frame 95 can be rotated from the evacuated state with the rotational end of the main frame 951 facing upward to the use state with the rotational end of main frame 951 facing forward.

As shown in FIGS. 1 and 3, the armrest brackets 141, 142 are laser-welded to the front of the set bracket 11 at the lower end of the front panel frame 20 and to the front of the front panel frame 20, left side of the opening 243, to be horizontally arranged.

The armrest brackets 141 and 142 are members of a metal plate thicker than the front panel frame 20 and rear panel frame 30, which are pressed into a specified structure. The armrest brackets 141, 142 have a base joined opposite the front surface of the set bracket 11 or the front surface of the front panel frame 20, and an arm bent from the base and extended forward. A support hole into which the armrest rotation shaft 952 is inserted and an arc-shaped regulation hole into which the regulation shaft 953 is inserted are formed through the end of the arm in the left-right direction. The armrest brackets 141, 142 have flanges formed on their outer edges from the bases to the arms to enhance the support strength of the armrest frame 95.

### [Retractor Bracket]

The retractor bracket 96 supports the seat belt retractor inside the aforementioned attachment hole 244 in the front panel frame 20.

The retractor bracket 96 has a support plate 961 that supports the seat belt retractor (not shown) from the rear, and three support arms extending forward from the left and right ends and the lower end of the support plate 961, the end of each support arm being joined to the inner edge of the attachment hole 244 on the rear surface of the front panel frame 20.

The retractor bracket 96 has the rear surface of the support plate 961 positioned behind the rear surface of the body plate 31 of the rear panel frame 30 and protruding behind the body plate 31 through the aforementioned opening 354 due to the structure described above.

This allows the rear of the seat belt retractor to be arranged behind the rear surface of the panel frame structure 100. The seat belt from the seat belt retractor can then be pulled out from the rear of the panel frame structure 100 through the attachment hole 244 and opening 354 to the front via the upper side.

In the center of the support plate 961, an approximately V-shaped attachment reinforcement 962 is formed, which bulges out in a forward convex direction.

In the center of the attachment reinforcement 962, a shaft 963 of a rivet protrudes forward through the rear side of the attachment reinforcement 962, and the head of the rivet is joined to the rear side of the attachment reinforcement 962 and fixed. The seat belt retractor is fixed to the shaft 963 of rivet protruding forward from the attachment reinforcement 962. The seat belt retractor may be joined to the front surface of the attachment reinforcement 962, or it may be fixed by both attachment to the shaft 963 and joint to the front surface of the attachment reinforcement 962.

### [Belt Guide]

The belt guide 16 is a member that guides the seat belt drawn from the seat belt retractor (not shown) supported by the retractor bracket 96 from the rear side of the panel frame structure 100 to the front side.

The belt guide 16 is laser-welded to the upper edge of the front panel frame 20 and rear panel frame 30 and to the upper side of the seat belt retractor supported by the retractor bracket 96, as shown in FIGS. 1 and 3.

The belt guide 16 is a member of a metal plate thicker than the front panel frame 20 and rear panel frame 30, which is pressed into a specified structure.

The belt guide 16 has a joint that is joined to the top of the front panel frame 20 and the rear panel frame 30, the top of which guides the seat belt from rear to front.

### [Lock]

The lock 17 is a member for locking the panel frame structure 100 in a predetermined posture (for example, in the raised state shown in FIG. 1) with the lower end of the panel frame structure 100 being rotatably supported by a rotation axis along the left-right direction with respect to the vehicle seat.

As shown in FIGS. 1 and 3, the lock 17 is supported by a lock support bracket 171 that is laser-welded to the right end of the front panel frame 20, that is, to the front side near the upper end of the right frame reinforcement 224.

The lock 17 is supported by the lock support bracket 171 in a rotatable manner around an axis along the left-right direction and is energized by a wire spring in a predetermined rotational direction.

The lock 17 has a receiving groove that accepts a locking pin, not shown, extended to the left in the attachment position of panel frame structure 100. The lock 17 rotates when the tip of the locking pin is accepted in the receiving groove and also rotates backward by the spring of the wire to lock the locking pin and hold the panel frame structure 100 in a predetermined posture.

The lock support bracket 171 is a member made of a metal plate thicker than the front panel frame 20 and the rear panel frame 30 and pressed into a specified structure.

The lock support bracket 171 has legs that are joined to the front and right sides of the upper end of the right frame reinforcement 224.

Then, with respect to the attachment position of the lock 17 and lock support bracket 171, one of the outer edge reinforcements 341, 344 is located adjacent in the up-down direction, the left-right direction, or the composite direction of up-down and left-right directions in the rear panel frame 30. Therefore, through the rear panel frame 30, the rigidity around the attachment positions of the lock 17 and lock support bracket 171 on the front panel frame 20 side is increased, and the attachment strength of the lock 17 and lock support bracket 171 can be improved.

### [Panel Frame Structure (2)]

As shown in FIGS. 1 and 2, the panel frame structure 500 includes a front panel frame 70 as the first panel frame, a rear panel frame 80 as the second panel frame, set brackets 511, 512 for attaching the panel frame structure 500 externally, a headrest support 513, a tether 515, and a lock 517.

Both the front panel frame 70 and the rear panel frame 80 are metal plates such as steel or aluminum alloy with an approximately rectangular plate shape in front view.

Both the front panel frame 70 and the rear panel frame 80 have their short sides in front view along the left-right direction and their long sides along the up-down direction, and unlike the panel frame structure 100 described above, have narrower horizontal widths (widths in the left-right direction) and are longer vertically.

The front panel frame 70 and the rear panel frame 80 have the front side on the front side of the drawing sheet in FIG. 1 and the opposite side on the rear side. The front panel frame 70 is joined to the front side of the rear panel frame 80.

### [Schematic of Front Panel Frame]

The rear panel frame 80 has a low circumferential flange 804 that is raised forward at the right end, and the front panel frame 70 is joined to the rear panel frame 80 in a front-to-rear overlapping configuration, as shown in FIGS. 1 and 2.

### [Front Panel Frame: Frame]

The front panel frame 70 has an outer edge 71 that is in surface contact with the front surface of the rear panel frame 80 over its entire outer edge, and a frame 72 located just inside the outer edge 71.

The outer edge 71 is joined to the front of the rear panel frame 80 on the rear side.

The frame 72 is separated from the front surface of the rear panel frame 80 and bulges out forward along the four sides of the approximate rectangle, with an upper frame reinforcement (frame portion) corresponding to the upper side, a lower frame reinforcement (frame portion) corresponding to the lower side, a left frame reinforcement (frame portion) corresponding to the left side, and a right frame reinforcement (frame portion) corresponding to the right side.

The inside of the frame 72 has an opening 741 which is widely open in an approximately rectangular shape. The front panel frame 70 of the panel frame structure 500 does not have a configuration equivalent to the connection 23 of the panel frame structure 100.

This is because the front panel frame 70 of the panel frame structure 500 has a vertical width (width in the up-down direction) almost equal to that of the front panel frame 20, but its horizontal width is narrower, about ½ to ⅔ of the front panel frame 20, and it can ensure sufficient rigidity against stress in each direction even without a configuration corresponding to the connection 23.

The frame 72 of the front panel frame 70 is overall bulging forward, but the inner edge of the opening 741 is depressed to the rear. The inner edge of the opening 741 of the front panel frame 70 is joined to the front surface of the opening inner edge reinforcement 838, which consists of an annular protrusion convex to the front along a position corresponding to the inner edge of the opening 741 of the rear panel frame 80.

### [Schematic Of Rear Panel Frame]

As shown in FIGS. 1 and 2, the rear panel frame 80 has a plate-like body plate 81 that is approximately rectangular in front view, and the aforementioned flange 804 and beads 801-803 integrally provided on the outer edge of the body plate 81.

The body plate 81 is a flat plate that is overall flat along the up-down and left-right directions.

The flange 804 consists of a low height wall portion that is erected forward from the right edge of the approximately rectangular body plate 81. The flange 804 is a reinforcement that increases the rigidity of the right edge of the body plate 81.

The beads 801-803 consist of protrusions along each of the upper, lower, and left edges of the approximately rectangular body plate 81, which bulge out more toward the front than the perimeter. The beads 801-803 are all convex forward from the front surface of the body plate 81, and concave forward when viewed from the rear surface. The top and bottom beads 801, 802 both have flat fronts and are in contact with the outer edge 71 of the front panel frame 70. The mutual contacting surfaces of beads 801, 802 and outer edge 71 may be joined.

### [Rear Panel Frame: Opening Reinforcement]

With the front panel frame 70 overlapping with the rear panel frame 80, a plurality of opening reinforcements 821-823 are formed in the area that is inside each opening 741 of the front panel frame 70 in the body plate 81. All of these opening reinforcements 821-823 are convex forward from the front surface of the body plate 81, and concave forward when viewed from the rear surface.

Each of the opening reinforcements 821-823 is an elliptical shape along the up-down direction. The opening reinforcement 821 and the opening reinforcement 822 are aligned in the same up-down straight line and are arranged at the left end in the area within the opening 741.

The opening reinforcement 823 is arranged at the right end in the area within the opening 741 and is integrally formed with the joint reinforcement 853 described below.

The aforementioned opening inner edge reinforcement 838 is formed to surround these opening reinforcements 821-823.

Each of the opening reinforcements 821-823 has a plurality of through holes vertically arranged with an inner diameter smaller than its horizontal width.

The left ends of the opening reinforcements 821 and 822, which are located at the left end in the area within the opening 741, are approximately parallel and close enough to each other that they do not touch each other along the left end (proximity portion) at the inner edge of the opening 741.

The right end of the opening reinforcement 823, which is located at the right end in the area within the opening 741, is approximately parallel to and close enough to the right end (proximity portion) in the inner edge of the opening 741 that they do not touch each other.

### [Rear Panel Frame: Outer Edge Reinforcement]

In the area around the outer edge of the body plate 81 of the rear panel frame 80, that is, the area in the body plate 81 that does not overlap with the opening 741 of the front panel frame 70 (the area that is outside the opening 741, the area overlapping the frame 72) with the front panel frame 70 overlapping with the rear panel frame 80, a plurality of outer edge reinforcements 841 are formed. Each outer edge reinforcement 841 consists of a line-shaped bead that is convex forward from the front surface of the body plate 81 and concave forward when viewed from the rear surface.

The body plate 81 is approximately rectangular in front view, with plurality of outer edge reinforcements 841 arranged in the outer circumference of the body plate 81, in an area corresponding to the upper side of the body plate 81 (area overlapping with the upper frame reinforcement), an area corresponding to the lower side (area overlapping with the lower frame reinforcement), an area corresponding to the left side (area overlapping with the left frame reinforcement) and an area corresponding to the right side (area overlapping with the right frame reinforcement).

The plurality of outer edge reinforcements 841 provided in areas corresponding to the respective top, bottom, left, and right sides of the body plate 81 are all formed along a direction inclined (non-parallel direction, for example, left diagonally downward) to the respective top, bottom, left, and right sides of the body plate 81. Some of the outer edge reinforcements 841 have a different direction(s) of extension (inclination angle) than that of the other outer edge reinforcements 841. The inclination angle of one or more outer edge reinforcement 841 may be configured to be different from the others, or the inclination angles of all the outer edge reinforcements 841 may be different from all the others.

Some of the outer edge reinforcements 841 are different in length from the other outer edge reinforcements 841.

Although some of the outer edge reinforcement 841 is connected to the opening inner edge reinforcement 838, all of the outer edge reinforcements 841 may be configured not to be connected to other reinforcements, or some or all of the outer edge reinforcements 841 may be connected to other reinforcements.

### [Rear Panel Frame: Tether]

The tether 515 is also used to attach the child seat to the panel frame structure 500.

As shown in FIGS. 1 and 2, the tether 515 is almost identical in construction to the tether 15 described above.

The tether 515 and the clearance hole 851 are arranged between the two vertically arranged opening reinforcements 821, 822.

A pair of joint ends extending downward from both ends of the horizontal bar of the tether 515 are joined to the joint reinforcement 853 formed in the area within the opening 741 and between the opening reinforcements 821, 822.

The joint reinforcement 853, to which the pair of joint ends of the tether 515 are joined, is integrally formed with the opening reinforcement 823 and the opening inner edge reinforcement 838 in the rear panel frame 80. The joint reinforcement 853, to which the pair of joint ends of the tether 515 are joined, is located adjacent to other opening reinforcements 821, 822, 823 or opening inner edge reinforcement 838 around it, or arranged between any of these.

Thus, the rigidity and strength around the tether 515 is improved, and the connected child seat can be held firmly.

### [Set Bracket]

The right set bracket 511 is laser-welded to support arms (not shown) extending to the right from the front side at the lower right end of the front panel frame 70 and the lower right end of the rear panel frame 80, as shown in FIGS. 1 and 2.

The left set bracket 512 is laser-welded to support arms (not shown) extending to the left from the front side of the front panel frame 70 at the lower left end of its front surface and the lower left end of the rear panel frame 80.

Set brackets 511, 512 are connected to legs 93, 594, which are erected on the installation surface of the seat via connecting brackets 591, 592, respectively.

Each of the set brackets 511, 512, like the set brackets 11, 12 described above, has a base and an extension, and a flange is formed on the outer edge of these parts. Projection nuts are also fixed to the rear side of the respective extensions of the set brackets 511, 512 by projection welding.

These projection nuts are used to connect the base of the connecting brackets 591, 592 to the rear side of the extension of the set brackets 511, 512, where the connecting bolts are screwed in. The set brackets 511, 512 and connecting brackets 591, 592 may be joined by welding or by both bolts and welding, not limited to connection by bolts.

The connecting brackets 591, 592 have arms that are raised forward from the base. The connecting brackets 591, 592 have a flange formed on the outer edge from the base to the arm. The arms of the connecting brackets 591, 592 have the outer left and right sides facing those of the legs 93, 594, which are fixed to the installation surface where the seat that is framed by the panel frame structure 500 is installed, and are rotatably connected around an axis along the left-right direction mutually.

### [Headrest Support]

As shown in FIGS. 1 and 2, the headrest support 513 has the same structure as the aforementioned support 132, and are joined in pair by laser welding to the front side at the center of the inclined surface 725 of the upper end of the frame 72 of the front panel frame 70 in the left-right direction.

Between the two headrest supports 513 in the inclined surface 725 of the front panel frame 70, a reinforcement 726 of the same structure as the aforementioned reinforcement 227 is formed to increase the rigidity of the inclined surface 725 and improve the support strength of the headrest.

### [Lock]

The lock 517 is almost identical in function and structure to the lock 17 described above.

However, as shown in FIGS. 1 and 2, this lock 517 is supported by a lock support bracket 571 that is laser-welded to the front side near the top of the left end of the frame 72 of the front panel frame 70.

The lock 517 also has a receiving groove that accepts a locking pin, not shown, extended to the right in the attachment position of panel frame structure 500, and when the tip of the locking pin is accepted, lock 517 rotates and returns to the reverse direction by the spring of the wire to lock the locking pin and hold the panel frame structure 500 in a predetermined posture.

### [Technical Effects of Embodiment]

In the above panel frame structures 100, 500, the rear panel frames 30, 80 have opening reinforcements 321, 821-823 and joint reinforcements 352, 353, 853 at positions corresponding to openings 241-243, 741 of the front panel frames 20, 70. Thus, while reducing weight by the openings 241-243, 741, the reinforcements 321, 352, 353, 821-823, 853 can reinforce so that the openings 241-243, 741 do not cause a reduction in strength, thus making it possible to reduce weight while maintaining high strength.

The opening inner edge reinforcements 338, 339, 340, 838 of the rear panel frames 30, 80 also have the effect of reinforcing so that there is no reduction in strength due to the openings 241-243, 741.

In addition, the panel frame structure 500 has through holes in the opening reinforcements 821-823, which further reduces weight. In particular, since through holes are formed in the bulged face portions of the opening reinforcements 821-823, the strength of the opening reinforcements 821-823 is not compromised, allowing for further weight reduction while maintaining a high level of strength.

The panel frame structures 100, 500 also have rear side connection reinforcements 331-333 and outer edge reinforcements 341-344, 841 in the rear panel frames 30, 80 at positions that do not overlap with the openings 241-243, 741 of the front panel frames 20, 70, so that through the rear panel frames 30, 80, it is possible to further improve the strength of the entire panel frame structures 100, 500.

In the panel frame structures 100, 500, the opening reinforcements 321, 821-823, rear side connection reinforcements 331-335, opening inner edge reinforcements 338-340, 838, outer edge reinforcements 341-344, 841, and joint reinforcements 352, 353, 853 of the rear panel frames 30, 80 are all convex to the front panel frame 20, 70 side, flexure in each reinforcement is suppressed and strength can be improved.

Furthermore, since each of the above reinforcements of the rear panel frames 30, 80 is convex toward the front panel frames 20, 70, when there is a gap area between the front panel frames 20, 70 and the rear panel frames 30,80, each reinforcement can be arranged in the gap area, and the front panel frames 20, 70 and rear panel frames 30,80 can be made thinner in the overlapping direction.

In the panel frame structures 100, 500, the rear panel frames 30, 80 have a plurality of reinforcements such as opening reinforcements 321, 821-823, rear side connection reinforcements 331-335, opening inner edge reinforcements 338-340, 838, outer edge reinforcements 341-344, 841, and joint reinforcements 352, 353, 853. These reinforcements can be used to further improve the strength of the product.

In this case, since the above plurality of reinforcements include those with different shapes from each other, it is possible to improve strength in more directions according to the shape of each reinforcement, and to suppress the reduction in strength that occurs biased in a certain direction.

Furthermore, since the plurality of reinforcements described above include those that extend in different directions, it is possible to improve strength in more directions in accordance with the respective extension directions of the above reinforcements, and to suppress the reduction in strength that occurs biased in a certain direction.

In addition, since the panel frame structures 100, 500 have the opening inner edge reinforcements 338-340, 838 corresponding to the openings 241-243, 741 having portions along the inner edges of the openings 241-243, 741, the opening inner edge reinforcements 338-340, 838 can be placed close to the inner edge of the openings 241-243, 741. Since the inner edge reinforcements 338-340, 838 are arranged in close proximity along the inner edge of the openings 241-243, 741, it is possible to effectively suppress the reduction in strength that occurs near the inner edge of the openings 241-243, 741.

In particular, when the openings 241-243,741 are configured with opening reinforcements 321, 821-823, joint reinforcements 352, 353, 853, and opening inner edge reinforcements 338-340,838, the boundary portions of opening reinforcements 321, 821-823, joint reinforcements 352, 353, 853, and inner edge reinforcements 338-340,838 within openings 241-243,741 are formed as protrusions that are convex rearward. Thus, the boundary portions also function as reinforcements and can more effectively improve the strength.

The panel frame structures 100, 500 can hold the child seat with high strength through the tethers 15, 515 because the tethers 15, 515 are attached to the joint reinforcements 352, 353, 853.

Furthermore, since the joint reinforcements 352, 353, 853 are arranged between other reinforcements such as the opening reinforcements 321, 821-823, the rear side connection reinforcements 331-335, and the opening inner edge reinforcements 338, 339, 838, the periphery of the joint reinforcements 352, 353, 853 to which the tethers 15, 515 are attached are strengthened and the child seat can be held with even higher strength.

In the panel frame structure 100, the front panel frame 20 has a frame 22 and a connection 23, with openings 241-243 between the frame 22 and the connection 23. This makes it possible to reduce weight due to openings 241-243, while the connection 23 acts like a brace to suppress deformation of the frame 22 and increase rigidity.

In addition, the connection 23 can be lighter than if it were constructed to connect along two diagonals that cross in an X shape with respect to the frame 22.

Furthermore, since the connection 23 is provided with front side connection reinforcements 234-236, the connection 23 supports the frame 22 with high rigidity, which improves the overall strength of the panel frame structure 100 through the front panel frame 20.

The front side connection reinforcement 236 among the front side connection reinforcements 234-236 is provided along the right extension 233 and from the left end of the upper frame reinforcement 221 to the right end of the lower frame reinforcement 222, so the front side connection reinforcement 236 acts like a brace to suppress deformation of the frame 22 and increase rigidity.

Since these front side connection reinforcements 234-236 are separated, not integrated, at the branching position, the length of each front side connection reinforcement 234, 235 can be shortened, and the rigidity of each front side connection reinforcement 234, 235 against bending can be increased to improve the strength of panel frame structure 100.

In addition, because the panel frame structure 100 has a structure in which the front side connection reinforcements 234-236 are convex toward the rear panel frame 30, flexure in the front side connection reinforcements 234-236 is suppressed and strength can be improved.

Furthermore, since the front side connection reinforcements 234-236 are convex toward the rear panel frame 30, when the front panel frame 20 and rear panel frame 30 have a gap area, the front side connection reinforcements 234-236 can be arranged in the gap area, and this makes it possible to reduce the thickness of the front panel frame 20 and rear panel frame 30 in the overlapping direction.

Furthermore, some of the front side connection reinforcements 234-236 are provided to be arranged with the tether 15 in the up-down direction, and others of the front side connection reinforcements 234-236 are provided to be arranged in the left-right direction with the tether 15, so the front side connection reinforcements 234-236 reinforce the area around the tether 15, enabling the child seat to be held in high strength.

Since the panel frame structure 100 has a seat belt retractor bracket 96 in the connection 23, the strength of the connection 23 itself also acts on the retractor bracket 96, making it possible to improve the strength of the retractor and other components to be attached.

Furthermore, since the above retractor bracket 96 is provided inside the central extension 231 of the connection 23 and the retractor bracket 96 itself has a attachment reinforcement 962, it is possible to improve the strength of the surroundings of the retractor bracket 96 and the retractor bracket 96 itself, further increasing the strength of the retractor and other components attached to the retractor bracket 96.

In addition, since the panel frame structures 100, 500 have outer edge reinforcements 341-344, 841 provided to be inclined to the outer edge of the rear panel frames 30, 80, it is possible to suppress flexure occurring at the outer edge of the rear panel frames 30, 80 and improve the overall strength of the panel frame structures 100, 500. In particular, a plurality of outer edge reinforcements 341-344, 841 are provided, which further improves the strength of the outer edges of the panel frame structures 100, 500, depending on the number.

Since the outer edge reinforcements 341-344, 841 include those having different directions of extension, it is possible to suppress flexure for a different plurality of directions, suppress strength reduction that occurs biased in a certain direction, and further improve the strength of the panel frame structures 100, 500.

Furthermore, when flanges 301, 804 and beads 302-304, 801-803 are provided on the outer edge of the rear panel frame 30, 80, rigidity and strength can be improved according to the direction of extension of the flanges 301, 804 and beads 302-304, 801-803, but each outer edge reinforcement 341-344, 841 are provided to be inclined with respect to the outer edge of the rear panel frame 30, 80, so that the rigidity and strength can be improved according to the different direction from that of the flanges 301, 804 and beads 302-304, 801-803, enabling the panel frame structures 100, 500 to endure stresses from more directions.

The panel frame structures 100, 500 are also connected to other reinforcements of the rear panel frames 30, 80, such as the opening inner edge reinforcements 338-340, 838 and any of the outer edge reinforcements 341-344, 841, which together provide extensive reinforcement and improve the strength of the panel frame structures 100, 500. In addition, the fact that the reinforcements are connected to each other makes it possible to suppress the reduction of strength at the boundaries of the reinforcements.

Since the panel frame structures 100, 500 have beads 302, 303, 801, 802 on the upper and lower portions of outer edges of the rear panel frames 30, 80, flexure of both the upper and lower portions of outer edges of the rear panel frames 30, 80 is suppressed and the overall strength of the panel frame structures 100, 500 is improved. In addition, since reinforcement is not achieved by adding new members, it is possible to improve strength while reducing weight.

In the panel frame structures 100, 500, the outer edge reinforcements 341-344, 841 are arranged in either direction along the plate surface of the body plates 31, 81 with respect to the locks 17, 517, so that the periphery of the locks 17, 517 of the front panel frames 20, 70 are strengthened by the outer edge reinforcements 341-344, 841 through the rear panel frames 30, 80, and the attachment strength of the panel frame structures 100, 500 can be improved.

In addition, the panel frame structures 100, 500 have outer edge reinforcements 341-344, 841 to increase the rigidity of the front panel frames 20, 70 except at positions corresponding to the openings 241-243, 741, so that overall flexure due to strength reduction of the front panel frames 20, 70 due to openings 241-243,741 is suppressed, and weight reduction by openings 241-243,741 can be achieved without causing a reduction in overall strength.

The panel frame structures 100, 500 have outer edge reinforcements 343, 344, 841 between which the tethers 15, 515 are arranged, so that the area around the portion where the tethers 15, 515 are attached is strengthened and the child seat can be held with high strength.

### [Others]

The various reinforcements formed in the front panel frames 20, 70 and rear panel frames 30, 80 of the panel frame structures 100, 500 are all examples of structures in which the plates of the front panel frames 20, 70 and rear panel frames 30, 80 are deformed to form convex portions or protrusions to increase strength and rigidity. However, the structure of the reinforcement is not limited to this, but may utilize, for example, a structure in which bends are formed in the plates of the front panel frame 20, 70 or rear panel frame 30, 80 to increase strength and rigidity.

However, it is more preferable that the various reinforcements described above do not consist of joining or attaching new members to the front panel frames 20, 70 or rear panel frames 30, 80, but rather deforming or otherwise modifying the plate material of the front panel frames 20, 70 or rear panel frames 30, 80 to increase strength and rigidity.

According to the above-described embodiments of the present disclosure, there is provided a panel frame structure comprising a first panel frame and a second panel frame, wherein the first panel frame and the second panel frame are joined in an overlapping state, the first panel frame includes: a frame along an outer edge; and a connection that is extended from a middle portion in a left-right direction of one frame portion extending in the left-right direction of the frame, and branches halfway to reach ends in the left-right direction of the other frame portion extending in the left-right direction of the frame, and an opening is formed between the frame and the connection.

With this configuration, the first panel frame has a frame and a connection, and an opening is formed between the frame and the connection. Therefore, the connection acts as a brace to suppress deformation of the frame, increasing rigidity and reducing weight by the opening.

In addition, the weight can be reduced more than in the case where the connection is formed along two diagonals that intersect in an X shape.

It is preferred that the connection is provided with a reinforcement.

With this configuration, the connection is provided with a reinforcement, so that the rigidity of the connection is increased and the overall strength of the panel frame structure can be improved.

It is preferred that the connection is in a bifurcated shape, and the reinforcement includes a reinforcement provided from one end in the left-right direction of the one frame portion of the frame to the other end in the left-right direction of the other frame portion of the frame.

With this configuration, the reinforcement includes a reinforcement provided from one end in the left-right direction of one frame portion of the frame to the other end in the left-right direction of the other frame portion of the frame, so that the reinforcement acts as a brace to suppress deformation of the frame and increase rigidity, thereby increasing the rigidity of the entire connection. Thus, the overall strength of the panel frame structure can be improved.

It is preferred that each of the reinforcement is not integrated at a branching position of the connection.

With this configuration, each of the reinforcements is not integrated at the branching position, so that the length of some of the reinforcements can be shortened and the rigidity of each reinforcement can be increased to improve the strength of the panel frame structure.

It is preferred that the reinforcement is convex toward the second panel frame.

With this configuration, the reinforcement is convex toward the second panel frame, so that flexure in the reinforcement is suppressed and the strength of the panel frame structure can be improved.

Moreover, since the reinforcement is convex toward the second panel frame, the reinforcement can be placed in the gap area between the first panel frame and the second panel frame, and it is possible to make the panel frame structure thinner in the overlapping direction.

It is preferred that the panel frame structure further comprises a tether for fastening a child seat, the tether being attached to the second panel frame, and the reinforcement is provided to be arranged in an up-down direction with the tether.

With this configuration, the reinforcement is arranged with the tether in the up-down direction, so that the area around the tether is strengthened by the reinforcement and the child seat can be held with high strength.

It is preferred that the panel frame structure further comprises a tether for fastening a child seat, the tether being attached to the second panel frame, and the reinforcement is provided to be arranged in the left-right direction with the tether.

With this configuration, the reinforcement is arranged in the left-right direction with the tether, so that the area around the tether is strengthened by the reinforcement and the child seat can be held with high strength.

It is preferred that the panel frame structure further comprises a retractor attachment for attaching a seat belt retractor, the retractor attachment being provided in the connection.

With this configuration, the connection is provided with a retractor attachment for attaching a seat belt retractor, so that the strength of the connection itself acts on the retractor attachment to improve the attachment strength of the seat belt retractor at the retractor attachment.

It is preferred that the retractor attachment is provided with a reinforcement.

With this configuration, the retractor attachment is provided with a reinforcement, so that the retractor attachment can be held with even higher strength.

Although embodiments of the present disclosure have been described and illustrated in detail, the disclosed embodiments are made for purposes of The scope of the present disclosure should be interpreted by terms of the appended claims.

What is claimed is:

1. A panel frame structure comprising a first panel frame and a second panel frame, wherein
the first panel frame and the second panel frame are joined in an overlapping state,
the first panel frame includes:
a frame along an outer edge; and
a connection that is extended from a middle portion in a left-right direction of one frame portion extending in the left-right direction of the frame, and branches halfway to reach ends in the left-right direction of the other frame portion extending in the left-right direction of the frame, and
an opening is formed between the frame and the connection.

2. The panel frame structure according to claim 1, wherein the connection is provided with a reinforcement.

3. The panel frame structure according to claim 2, wherein
the connection is in a bifurcated shape, and
the reinforcement includes a reinforcement provided from one end in the left-right direction of the one frame portion of the frame to the other end in the left-right direction of the other frame portion of the frame.

4. The panel frame structure according to claim 3, wherein each of the reinforcement is not integrated at a branching position of the connection.

5. The panel frame structure according to claim 2, wherein the reinforcement is convex toward the second panel frame.

6. The panel frame structure according to claim 2, further comprising a tether for fastening a child seat, the tether being attached to the second panel frame, wherein
the reinforcement is provided to be arranged in an up-down direction with the tether.

7. The panel frame structure according to claim 2, further comprising a tether for fastening a child seat, the tether being attached to the second panel frame, wherein
the reinforcement is provided to be arranged in the left-right direction with the tether.

8. The panel frame structure according to claim 1, further comprising a retractor attachment for attaching a seat belt retractor, the retractor attachment being provided in the connection.

9. The panel frame structure according to claim 8, wherein the retractor attachment is provided with a reinforcement.
